(19) United States
(12) Patent Application Publication
(10) Pub. No.: US 2007/0251330 A1
(43) Pub. Date: Nov. 1, 2007

(54) Flowmeter

(75) Inventors: David Howland, Aptos, CA (US); David Stadille, Salinas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Delaware Capital Formation, Inc., Wilmington, DE (US)

(21) Appl. No.: 11/404,711

(22) Filed: Apr. 13, 2006

(51) Int. Cl. G01F 1/22

(52) U.S. Cl. 73/861.57

(57) ABSTRACT

An apparatus, for use with a fluid moving device that moves a fluid from a container. The apparatus includes a flowtube having a passage, the flowtube having a first end and a second end. A body is positioned in the passage of the flowtube, and a sensor array comprising at least two sensors is positioned along the length of the flowtube and between the first end and second end of the flowtube. The sensors in the sensor array sense (e.g., detect) the body as the body flows past the sensors. The sensors in the sensor array are adapted to generate signals, and a controller is operatively coupled to the sensor array. The controller is adapted to control the fluid moving device in response to the signals generated by the sensor array.

### CROSS-REFERENCES TO RELATED APPLICATIONS

NONE

### BACKGROUND OF THE INVENTION

Commercially available pumps are capable of delivering small volumes of fluid at constant flow rates to target containers. A typical target container might be a washing machine that washes dirty clothes and typical fluids that may be dispensed may include detergents, bleach, etc. A typical commercially available pump might have a timer that controls the pump so that it delivers pre-determined amounts of liquids to the washing machine at predetermined times.

While conventional systems are useful, it is difficult to accurately dispense appropriate amounts of liquids using a simple timer. For example, different fluids can have different flow properties (e.g., different viscosities). Accordingly, one timer setting may be appropriate to dispense one type of fluid, but not another type of fluid. For example, one fluid may be thicker than another fluid and pumping these fluids at the same pressure and over the same time interval will result in different amounts of those fluids being dispensed.

In another example, the viscosity of some fluids may change under different conditions. For example, a fluid can change viscosity if heated or cooled. The changing viscosity can affect the flow rate of the fluid and this can affect how much fluid is dispensed into the target container.

Embodiments of the invention address these problems, and other problems, by providing for a more direct and accurate way to dispense fluids.

### SUMMARY OF THE INVENTION

Embodiments of the invention are directed to apparatuses and methods for dispensing fluids.

One embodiment of the invention is directed to an apparatus, for use with a fluid moving device that moves a fluid from a container. The apparatus includes a flowtube having a passage, the flowtube having a first end and a second end. A body is positioned in the passage of the flowtube, and a sensor array comprising at least two sensors is positioned along the length of the flowtube and between the first end and second end of the flowtube. The sensors in the sensor array sense (e.g., detect) the body as the body flows past the sensors. The sensors in the sensor array are adapted to generate signals, and a controller is operatively coupled to the sensor array. The controller is adapted to control the fluid moving device in response to the signals generated by the sensor array.

Another embodiment of the invention is directed to a system including the above-described apparatus.

Another embodiment of the invention is directed to a method for controlling fluid flow. The method includes flowing a fluid in a flowtube comprising a passage, where a body is in the passage, and sensing the body using sensors in a sensor array as the body is carried by the fluid. The method also includes generating signals using the sensor array, and controlling a fluid moving device that moves the fluid from a container to a target container using the generated signals.

Another embodiment of the invention is directed to an apparatus, for use with a fluid moving device that moves a fluid from a container. The apparatus comprises a flowtube having a passage, the flowtube having a first end and a second end. A body is positioned in the passage of the flowtube, and a sensor array comprising at least three sensors is positioned along the length of the flowtube and between the first end of the flowtube and the second end of the flowtube. The sensors in the sensor array are adapted to generate signals. The apparatus also includes a controller adapted to control the fluid moving device using the signals generated from the sensors in the sensor array and information relating to the viscosity of the fluid.

These and other embodiments of the invention are described in further detail below.

### BRIEF DESCRIPTION OF THE DRAWINGS

FIG. 1 shows a side, cross-sectional view of parts of a flowmeter according to an embodiment of the invention.

FIG. 2 shows a schematic block diagram of some components of a system according to an embodiment of the invention.

FIG. 3 shows a perspective view of a system according to an embodiment of the invention.

FIG. 4 shows a plurality of flowtubes in a housing.

FIGS. 5(A) and 5(B) show respectively different radial cross-sections of portions of a flowtube. The flowtube has a passage which runs through the flowtube, the passage having different cross-sectional areas at different axial locations.

### DETAILED DESCRIPTION

One embodiment of the invention is directed to an apparatus, for use with a pump that pumps a fluid from a container. Although fluid moving devices such as pumps are described in detail, it is understood that other fluid moving devices such as eductors and Venturi devices may be used instead. The apparatus comprises a flowtube having a passage, the flowtube having a first end and a second end. A body is positioned in the passage of the flowtube. A sensor array having at least two sensors is positioned along the length of the flowtube and between the first end of the flowtube and the second end of the flowtube. The sensors in the sensor array sense the body as the body flows past the sensors. The sensors in the sensor array are adapted to generate signals, and a controller is operatively coupled to the sensor array. The controller is adapted to control the pump in response to the signals generated by the sensor array.

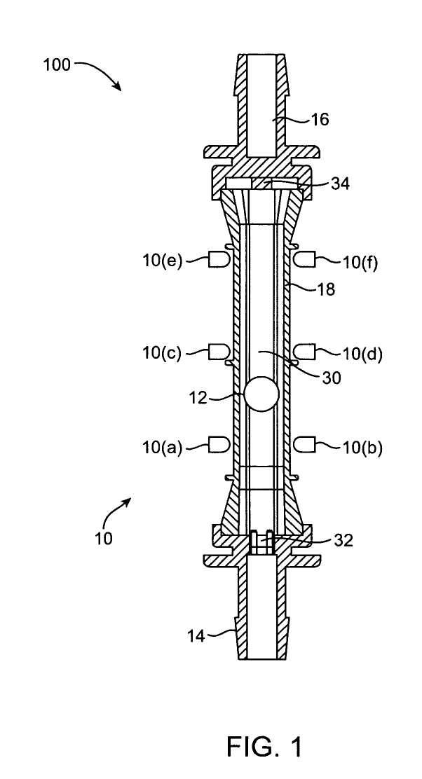

FIG. 1 shows part of a flowmeter 100 according to an embodiment of the invention. The flowmeter 100 includes a flowtube 18 having a first end 14 and a second end 16. In this example, the first end 14 has a fluid inlet while the second end 16 has a fluid outlet. A passage 30 may extend axially through the flowtube 18. It extends from the fluid inlet at the first end 14 of the flowtube 18 to the fluid outlet at the second end 16 of the flowtube 18.

A first stop structure 32 is at the first end 14 and a second stop structure 34 is at the second end 16 of the flowtube 18. The portion of the passage 30 that is defined by the first and second stop structures 32, 34, may be smaller than the portion of the passage 30 between the first and second stop structures 32, 34. The smaller portions of the passage 30 defined by the first and second stop structures 32, 34 inhibit the passage of a body 12 out of the flowtube 18. As a result, the first and second stop structures 32, 34 also confine the movement of the body 12 so that it moves between the first and second stop structures 32, 34.

The body 12 may be in any suitable form and may comprise any suitable material. For instance, the body 12 may have any suitable shape including a ball, and may comprise a material such as Teflon™ (polytetrafluoroethylene) Teflon™ is chemically resistant and has a specific gravity between about 2.13 and about 2.22. The body 12 may also have a cross-sectional dimension that is less than about 95% or 90% of the cross-sectional area of the passage 30 so that a fluid can pass around it and flow through the flowtube 18. In some embodiments, the body 12 and the cross-sectional area of the passage 30 may be designed so that the movement of the body 12 can indicate the flow rate of the fluid passing through the flowtube 18.

A sensor array 10 is also present in the flowmeter 100, and includes a plurality of sensors 10(a)-10(b), 10(c)-10(d), 10(e)-10(f). The sensors 10(a)-10(b), 10(c)-10(d), 10(e)-10(f) are disposed along the length of the flowtube 18 and detect the presence of the body 12 as it passes adjacent to them. In this example, each sensor 10(a)-10(b), 10(c)-10(d), 10(e)-10(f) comprises an optical detector 10(a), 10(c), 10(e) and a corresponding optical emitter 10(b), 10(d), 10(f). Suitable optical detectors and emitters are commercially available. If the sensor array 10 comprises optical emitters and optical detectors, then the flowtube 18 may be transparent or translucent to allow for the passage of light through it. Translucent or transparent tubes such as glass or polycarbonate tubes may be suitable.

Referring to FIG. 1, when the body 12 passes upward through the flowtube 18, light passing between corresponding optical emitter and optical detector pairs may be interrupted thereby signaling the presence of the body 12. The time that it takes for the body 12 to pass between adjacent sensors 10(a)-10(b), 10(c)-10(d), 10(e)-10(f) can be determined by a processor in a controller. Once the processor determines the travel time of the body 12 between the adjacent sensors 10(a)-10(b), 10(c)-10(d), 10(e)-10(f), the processor can then calculate the mass or volumetric flow rate since the dimensions of the passage 30 are known and the nature of the fluid being pumped is known. This provides for an accurate indication of the flow rate of the fluid that passes through the passage 30 and carries the body 12.

In this example, the first end 14 of the flowtube 18 faces down, and the second end 16 of the flowtube 18 faces up so that the flowtube 18 is vertically oriented. A fluid flowing through the flowtube 18 flows upward and pushes the body 12 upward in the passage 30.

Although the flowtube 18 may be oriented horizontally in some cases, it is preferably vertically oriented as shown in FIG. 1. As explained in detail below, when a fluid is intermittently dispensed to a target container, the body 12 may rise when the fluid is being pumped and may fall when the fluid is not pumped. As the body 12 passes upward and downward adjacent to the sensors in the sensor array 10, information about the fluid flow characteristics (e.g., the viscosity of the fluid, and/or the flowrate of the fluid) of the fluid may be obtained.

As explained above, each sensor 10(a)-10(b), 10(c)-10(d), 10(e)-10(f) measures the body 12 while the body is moving (e.g., at an average fluid velocity). As shown in FIG. 1, there is no sensor lateral to the first stop structure 32 so in this example, the body 12 is not sensed when it is at rest. It is more accurate to determine the velocity of the fluid passing through the flowtube 18 when at least two sensors sense the body 12 when it is moving, rather than when one sensor senses the body 12 at a rest position and another sensor senses the body 12 when it is moving. In the latter case, some time is needed for the body 12 to initially accelerate from an at rest state to the steady state speed of the flowing fluid. In the former case, since the body 12 is already moving at or close to the average fluid velocity when it passes by the sensors, a more accurate fluid velocity determination can be made. This results in more accurate fluid dispensing.

Although each sensor in the sensor array 10 in this example comprises an optical detector and an optical emitter, other types of sensors can be used in other embodiments of the invention. For example, in other embodiments, suitable electrical (e.g., inductive sensors) or magnetic detection systems could also be used instead of optical detectors and optical emitters.

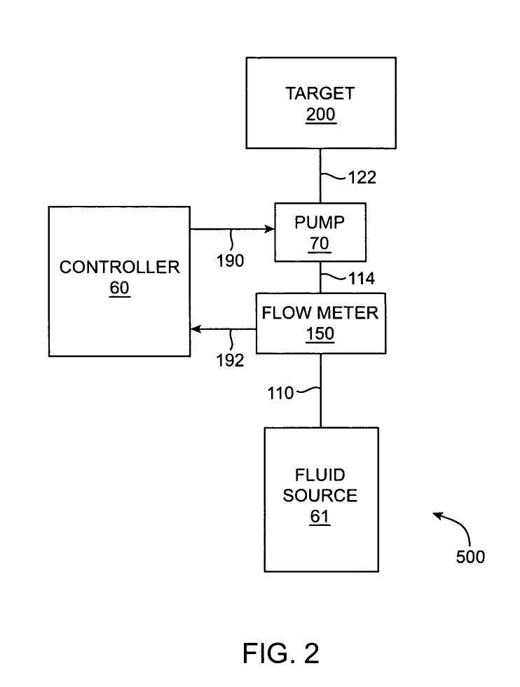

FIG. 2 shows a system 500 according to an embodiment of the invention. The system 500 includes a fluid source 60 which may be in the form of a container of fluid. The container of fluid may an industrial or household container containing a source fluid. Examples of source fluids include detergent additives, ingredients for mixtures, water, etc. In some cases, the source fluid may comprise a fluid that changes viscosity. In some cases, the fluid may exhibit a 10% or greater change in viscosity over a 10° C. change in temperature.

A flowmeter 150 of the type shown in FIG. 1 may be in fluid communication with the fluid source 60 via a first conduit 110. The flowmeter 150 may also be in fluid communication with a pump 70 via a second conduit 114. The characteristics the flowmeter 150 are provided above.

The fluid pump 70 and a target container 200 may be downstream of the fluid source 60, and may be connected together by a third conduit 122. The fluid pump 70 may be a commercially available fluid pump, and the first, second, and third conduits 110, 122 may include commercially available, flexible or rigid, pipes or tubes. The target container 200 may be any suitable container including a commercial mixer, washing machine, etc.

A controller 60 is in operative communication with the flowmeter 150. Signals can be sent from the flowmeter 150. The controller 60 may be a commercially available controller like the Eclipse™ controller which is commercially available from the assignee of the present invention, with programmed modifications to accommodate the previously described flowmeter. The controller 60 can receive signals from the flowmeter 150, and can subsequently generate control signals 190 to control the pump 70.

In some embodiments, the controller 60 may also receive signals from other data sources including thermometers, etc., which can sense changes in fluid properties. Data from these other data sources may also be used to generate control signals to control the pump 70.

The controller 60 may comprise a processor (e.g., a microprocessor), a computer readable medium, and suitable input devices (e.g., buttons, dials), and output devices (e.g., displays). The computer readable medium may use any suitable optical, magnetic, or electronic means for storing data.

The computer readable medium may include computer code for performing any of the functions of the controller. For example, the controller 60 may comprise a computer readable medium including code for receiving signals from the sensor array, code for determining the time that the previously described body takes to pass by and/or adjacent to various sensors, code for calculating a mass or volumetric flow rate, and code for causing the controller to generate signals to operate the pump 70 so that a predetermined amount of fluid can be dispensed to the target container 200. The computer readable medium may also include code for a lookup table or an equation which is used to control how the pump operates. The lookup table or equation may be derived from determined or predetermined fluid characteristics including fluid velocity and/or fluid viscosity.

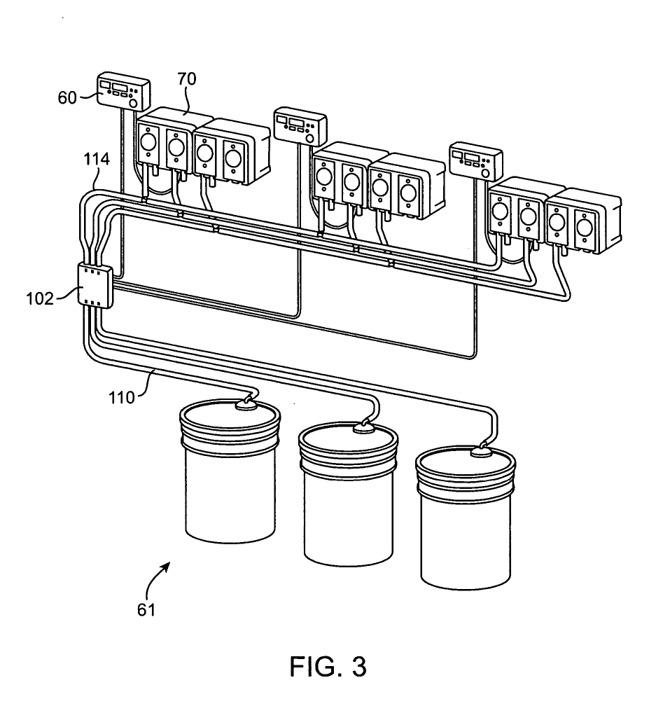

FIG. 3 shows a perspective view of an actual system which corresponds to the system shown in FIG. 2. In FIGS. 2 and 3, like numerals designate like elements and the same descriptions apply. Reference number 102 designates an array of flowtubes.

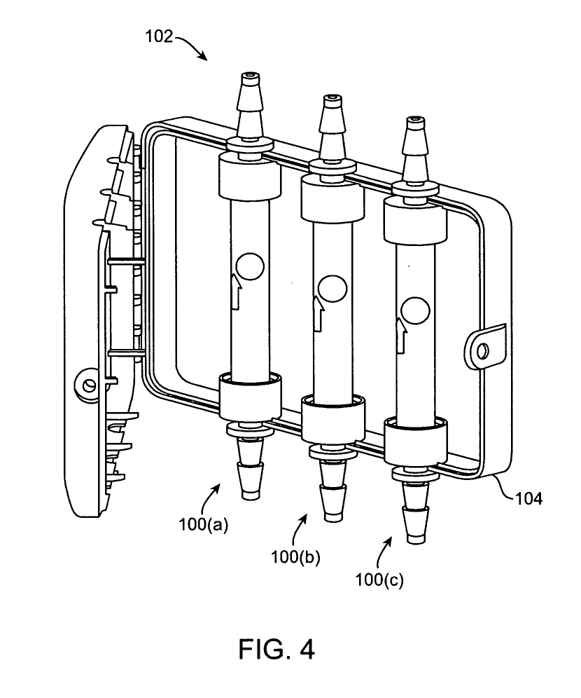

FIG. 4 shows an array 102 of three flowtubes 100(a), 100(b), 100(c) within a housing 104. As illustrated by FIG. 4, multiple flowtubes in a system according to an embodiment of the invention may be used if multiple fluids are to be dispensed. An operator can check all flowtubes at a single location to ensure that the appropriate amounts of fluids are being delivered to the particular process being run. The housing 104 also prevents dirt and dust from covering the flow tubes.

Embodiments of the invention provide for a low cost way to determine fluid flow rates over a range of fluid viscosities for a given fluid. As explained above, in embodiments of the invention, a sensor array provides flow rate information to a controller in a system, and the controller operates to control a pump. The controller controls the pump and can take the viscosity of the fluid into account when providing control signals to the pump.

In some embodiments, the system may be characterized over the range of viscosities for the fluid being pumped. From this characterization, a mathematical function is derived which describes the flow rate profile over the entire range of viscosities for that fluid when using a particular body, flowtube, and pump. The derived function can be stored as computer code on a computer readable medium built into or associated with the controller. The derived function may be in the form of an equation or a look-up table, thus enabling the controller to use the flow rate data to improve the accuracy of the dispensing of that fluid.

Embodiments of the invention can also be used to determine the flow rates of intermittent fluid flows for different fluids. For example, as noted above, a fluid flowtube according to an embodiment of the invention may contain a body such as a spherical ball, which is free to move up when the fluid entering the fluid flowtube pushes it up. At the top and bottom of the flowtube, there are structures which prevent the ball from passing outside of the flowtube, but allows fluid to pass into and out of the flowtube. As explained above, a multiplicity of optical light sensors can be used to measure the velocity of the ball as the ball passes by the optical sensors. The velocity of the ball relates directly to the rate of fluid flow. When the fluid stops flowing upward, gravity pulls the ball back down to the initial position in the flowtube.

The time that it takes for the ball to pass by adjacent optical sensor pairs on the way up as it is propelled by the upwardly flowing fluid, and the time that it takes for the ball to fall back down under gravity, can be used to determine the fluid flow rate for the characterized fluid. The latter time may provide an indication of the viscosity of the fluid, and the viscosity can be taken into account by the controller when controlling the pump.

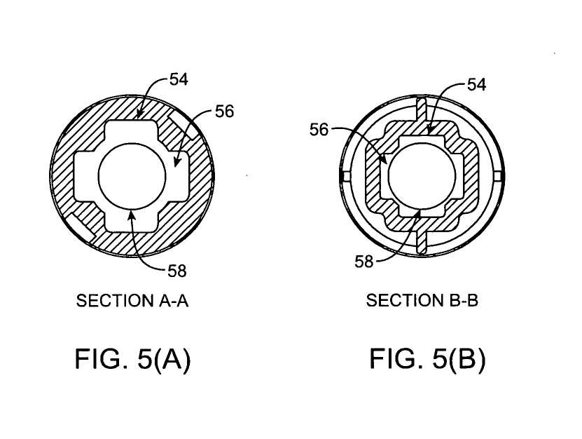

Several variables in combination may be used to refine the accuracy of the apparatus. For example, the shape of the passage in the flowtube can be designed to match the range of viscosity and fluid flow rates for the desired fluid. The flowtube could have a passage with different cross-sectional areas at different axial locations of the flowtube 54. For example, FIGS. 5(a) and 5(b) show cross-section A-A and cross-section B-B. These radial cross-sections may be at different axial locations along a single flowtube 54, and they show where fluid 56 may pass around a ball 58 in the flowtube 54. The different cross-sectional configurations of the passage portions in the flowtube 54 can be variables that can be used to characterize the fluid flow characteristics of a fluid over the range of viscosities and flow rates.

Referring to FIG. 5(a), if there is too much cross-sectional area around the ball 58, the ball 58 may not provide accurate data for use as a function of flow rate. This is because too much fluid will pass around the ball and the viscosity of the fluid will become too much of a factor in the signature of the movement of the ball. As the viscosity of the fluid decreases, and as the flow rate drops, there is a point where the ball 58 will no longer rise.

Referring to FIG. 5(b), the area where a fluid 56 can pass around the ball 58 and within the flowtube 54 is small. In this case, the velocity of the ball is more a component of the flow rate then the viscosity of the fluid 56. When area of the passage provided around the ball 58 is small, the time that it takes for the ball 58 to drop back down to its starting position will increase.

Useful information can be obtained when measuring the time that it takes for the ball to rise, and when measuring the time that it takes for the ball to fall. This information may be used to derive flow rate functions when characterizing a specific fluid and pump in a system according to an embodiment of the invention.

Illustratively, after a fluid flows upward through a flowtube, the ball falls back down in the flowtube after the pump stops. The time that it takes for the ball to fall is an indication of the viscosity of the fluid in the system. In most systems comprising a pump sensitive to changes in viscosity, increasing the viscosity of the fluid, results in a decrease in the flow rate of the fluid as it is more difficult for the pump to move it. By knowing the system's response to viscosity and by measuring the viscosity of the fluid, it is possible to more accurately control the pump so that the amount of fluid that is dispensed is more accurate.

It is noted that the ball can indicate more than just the system's response to viscosity and the flow rate of the fluid. For example, if the fluid flow rate is too low, the controller may be programmed to shut off the pump and/or sound an alarm indicating that the fluid flow rate is too low.

Embodiments of the invention can also use flowtubes with varying cross-sections, which are designed to minimize flow rate errors. The appropriate geometric profile and dimensions of the flowtube can provide a signature, which continues to yield the strongest flow-rate information over the range of flow rates and viscosities for a given fluid in a given system. When optimized, changes in viscosity in the fluid, and/or characteristics of the pump or conduits for the delivery of the fluid will contribute only small amounts of errors in the fluid flow measurements.

As noted above, the appropriate geometric profile will provide ball travel time signatures where their dominant variable is the velocity of the fluid. At one extreme, if there is no clearance around the ball at all, the ball will travel up the flowtube at the flow rate of the fluid. At another extreme, if there is a lot of clearance around the ball, the ball will not travel up at all. When the geometric profile is tested with laundry detergent, the time the ball is propelled upward was shown to be 82.7% based on a flow rate at 120° F., and 97% at 40° F. This shows that if the viscosity of a fluid changes by 10%, the error in the flow rate at 120° F., might be about 1.73% (the product of 17.3%×10%).

Embodiments of the invention have been tested (with laundry detergent) and provide flow data within +−10%. It has been demonstrated that a geometric profile with the appropriate dimensions providing a ball up velocity signature is good enough to measure the flow rate. Using non-linear regression, an equation was derived for the flow rate from the “ball up time” alone. The flow rate in ounces per second is described by this equation:
Flow Rate=(SQRT(18.134759/(Bˆ2−0.066699352)))/30

This represents the flow rate for a specific fluid to be used in a specific system over a range of viscosities and flow rates with the pump used to move the fluid. This equation may change if any other elements in the system change. In this example, B is the time the ball travels up past two sensor pairs. In the testing, only 2 optical sensors were used. However, as noted above, at least three sensor pairs may be used in other embodiments of the invention.

The use of at least three sensor pairs can allow for a second order of flow integration, if it is needed. In this manner, a second set of sensors can provide redundant capability as well as the potential for additional calculations to yield viscosity signatures at the beginning of fluid flow times. This data can be obtained in addition to the data that is already in the system.

By processing two ball velocity readings in two different sections of the flowtubes with different cross-sectional areas around the ball, it is possible to solve simultaneous equations to recognize the viscosity component in the signature and eliminate or reduce the source of viscosity-introduced error completely. It is possible to do this because the flow-rate is constant between the two sections and the slight shift in the two readings will indicate the viscosity of the fluid.

By comparing the viscosity of the fluid at the beginning of the dispensing cycle, together with the viscosity reading that can be determined at the end of the dispensing cycle (ball fall time), it is possible to provide for a cross check on the performance of the system.

In fitting the fluid viscosity curve with the pump's response to it, as a system, the independent errors are treated as a group and are not allowed to dominate. The design obtains flow rate as the dominant signature, minimizing the effect of viscosity, yet measures viscosity for the purpose of eliminating any small viscosity error from the measurement. When characterized for a specific fluid with a specific pump, this method of measuring flow need not consider the viscosity error to any great degree because the pump has a predicted response to viscosity. However, the method will take into account the viscosity of the fluid to eliminate even this small amount of error.

In embodiments of the invention, the flowtube device itself, in the simple form of providing data from the ball velocity between two sensor pairs in the flow tube, allows the controller to characterize the entire system (pumps, fluid conduits, and everything in any installed fluid delivery system). The data from the simple two pair sensors allows the controller to calibrate and make adjustments to the entire fluid delivery system's response to changes in fluid viscosity without measuring or knowing the fluid viscosity. There is simply a measurable difference in the movable body (ball) travel time in response to changes in fluid viscosity for a characterized system allowing the controller to make one order of magnitude of improvement in the dose of chemicals it delivers.

Where needed, the device itself may provide a controller with two sets of data (one for one cross-sectional area, and one for another cross-sectional area), to offer the controller the ability to improve the accuracy of the flow rate data.

And finally, the controller may use the time it takes the ball to fall after the flow has stopped to measure or check the accuracy of the fluid viscosity measurement it has made above, where more accuracy is called for.

In essence, embodiments of the invention provide data to a controller whereas the controller may use the data from the flowtube device to perform a viscosity compensating method of measuring fluid flow. It is unique and different from other flow measurement devices in that the device itself provides data to the controller allowing the controller to refine the accuracy of the fluid flow in several ways depending on the accuracy desired.

Although specific applications for embodiments of the invention are described above, the systems, apparatuses, and methods according to embodiments of the invention may be used in any suitable environment where fluids can be processed. For example, the system 500 may be used in the food and beverage industry, the petroleum industry, the semiconductor industry, the chemical processing industry, the garment cleaning industry, etc.

As understood herein, the use of the term “flow rate” above may include either or both of a mass flow rate, volumetric flow rate, or the like. As understood by those of ordinary skill in the art, they can be used interchangeably.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. An apparatus, for use with a fluid moving device that moves a fluid from a container, the apparatus comprising:
a flowtube having a passage, the flowtube having a first end and a second end;
a body positioned in the passage of the flowtube;
a sensor array comprising at least two sensors positioned along the length of the flowtube and between the first end of the flowtube and the second end of the flowtube, wherein the sensors in the sensor array sense the body as the body flows past the sensors, wherein the at least two sensors in the sensor array are adapted to generate signals and are positioned so that the at least two sensors sense the body as the body moves; and
a controller operatively coupled to the sensor array, wherein the controller is adapted to control the fluid moving device in response to the signals generated by the sensor array.

2. The apparatus of claim 1 wherein the flowtube comprises at least three sensors.

3. The apparatus of claim 1 wherein each sensor comprises an optical emitter and an optical detector.

4. The apparatus of claim 1 wherein the controller is configured to control the fluid moving device using the signals generated by the sensor array and a lookup table or an equation.

5. The apparatus of claim 4 wherein the lookup table includes information derived from different viscosities for the fluid under different conditions, and wherein the equation takes the viscosity of the fluid into account.

6. The apparatus of claim 5 wherein the different conditions include different temperatures.

7. The apparatus of claim 5 wherein each sensor comprises an optical emitter and an optical detector, and wherein there are at least three sensors in the sensor array.

8. A system comprising:
the apparatus of claim 1;
the fluid moving device operatively coupled to the apparatus; and
the container, wherein the container contains the fluid.

9. The system of claim 8 wherein the fluid changes viscosity in response to changes in temperature.

10. The system of claim 8 wherein the sensor array comprises at least three sensors.

11. A method for controlling fluid flow, the method comprising:
flowing a fluid in a flowtube comprising a passage, wherein a body is in the passage;
sensing the body using a sensor array comprising at least two sensors as the body moves and is carried by the fluid;
generating signals using the sensor array; and
controlling a fluid moving device that moves the fluid from a container to a target container using the signals.

12. The method of claim 11 wherein the target container runs a process and wherein the fluid moving device that moves the fluid into the target container intermittently while the process in the target container runs.

13. The method of claim 11 wherein the sensory array comprises at least three sensors.

14. The method of claim 11 wherein the sensors in the sensor array each comprise an optical detector and an optical emitter.

15. The method of claim 11 wherein the fluid changes viscosity in response to different conditions.

16. The method of claim 11 wherein the different conditions are different temperatures.

17. An apparatus, for use with a fluid moving device that moves a fluid from a container, the apparatus comprising:
a flowtube having a passage, the flowtube having a first end and a second end;
a body positioned in the passage of the flowtube;
a sensor array comprising at least three sensors positioned along the length of the flowtube and between the first end of the flowtube and the second end of the flowtube, wherein the sensors in the sensor array are adapted to generate signals; and
a controller adapted to control the fluid moving device using the signals generated from the sensors in the sensor array and information relating to the viscosity of the fluid.

18. The apparatus of claim 17 wherein the body is a ball.

19. The apparatus of claim 17 wherein each sensor comprises an optical emitter and an optical detector.

20. The apparatus of claim 17 wherein the passage has different cross-sectional areas at different axial locations in the flowtube.
